(19) United States
(12) Patent Application Publication
(10) Pub. No.: US 2026/0056455 A1
(43) Pub. Date: Feb. 26, 2026

(54) LIGHT SOURCE DEVICE AND PROJECTOR

(71) Applicant: SEIKO EPSON CORPORATION, Tokyo (JP)

(72) Inventor: Masaya MASUDA, MATSUMOTO-SHI (JP)

(21) Appl. No.: 19/306,449

(22) Filed: Aug. 21, 2025

(30) Foreign Application Priority Data
Aug. 22, 2024 (JP) 2024-141068

(51) Int. Cl. G03B 21/20; G03B 33/12

(52) U.S. Cl. CPC G03B 21/204; G03B 21/2066; G03B 33/12

(57) ABSTRACT

A light source device includes a light source that emits first light, a wavelength conversion layer that converts the first light incident from the light source into second light having a wavelength band different from that of the first light, a light transmissive substrate having a first surface and a second surface opposite to the first surface, the wavelength conversion layer being provided on the first surface side, a dichroic film that is provided between the first surface of the light transmissive substrate and the wavelength conversion layer, transmits the first light, and reflects the second light, and an uneven structure provided on the first surface side of the light transmissive substrate.

The present application is based on, and claims priority from JP Application Serial Number 2024-141068, filed Aug. 22, 2024, the disclosure of which is hereby incorporated by reference herein in its entirety.

### BACKGROUND

### 1. Technical Field

The present disclosure relates to a light source device and a projector.

### 2. Related Art

JP-A-2012-3923 discloses a light source device that causes excitation light to fall incident on a phosphor layer formed on a transparent substrate in order to generate illumination light including fluorescence and a portion of the excitation light. The excitation light emitted from the excitation light source is sequentially transmitted through the substrate and the dichroic layer, and then is incident on the phosphor layer. Of the fluorescence emitted from the phosphor layer in all directions, the fluorescence that travels toward the substrate side is reflected by the dichroic layer and extracted to opposite side to the substrate.

In the light source device of JP-A-2012-3923, a dichroic layer that transmits excitation light and reflects fluorescent light is provided between the substrate and the phosphor layer in order to extract the fluorescent light in a desired direction, that is, in a direction opposite from the substrate. However, of the fluorescence incident on the dichroic layer, the P-polarized component incident at Brewster's angle is transmitted through the dichroic layer and leaks into the substrate. The fluorescence leaking into the substrate propagates through the substrate by total reflection, and is emitted from the side surface of the substrate to the outside, and cannot be used as illumination light, and thus there is a problem that the light use efficiency of the fluorescence is reduced.

### SUMMARY

In order to solve the above problem, according to a first aspect of the present disclosure, a light source device includes a light source that emits first light; a wavelength conversion layer that converts the first light incident from the light source into second light having a wavelength band different from that of the first light; a light transmissive substrate having a first surface and a second surface opposite to the first surface, the wavelength conversion layer being provided on the first surface side; a dichroic film that is provided between the first surface of the light transmissive substrate and the wavelength conversion layer, transmits the first t light and reflects the second light; and an uneven structure provided on the first surface side of the light transmissive substrate.

According to a second aspect of the present disclosure, a projector includes the light source device according to the second aspect; a light modulation device that modulates light incident from the light source device; and a projection optical device that projects the light modulated by the light modulation device.

### BRIEF DESCRIPTION OF THE DRAWINGS

FIG. 1 is a schematic configuration diagram showing a projector.

FIG. 2 is a schematic configuration diagram showing a light source device.

FIG. 3 is a cross-sectional view showing the configuration of the wavelength conversion device.

FIG. 4 is a plan view showing the configuration of the wavelength conversion device.

FIG. 5 is a cross-sectional view showing a configuration of a wavelength conversion device according to a first modification.

FIG. 6 is a cross-sectional view showing a configuration of a wavelength conversion device according to a second modification.

### DESCRIPTION OF EMBODIMENTS

Hereinafter, embodiments of the present disclosure will be described in detail with reference to the drawings. In addition, the drawings used in the following description may show characteristic parts in an enlarged scale for convenience in order to make the features easier to understand, and the dimensional ratios of each component may not necessarily be the same as the actual ones.

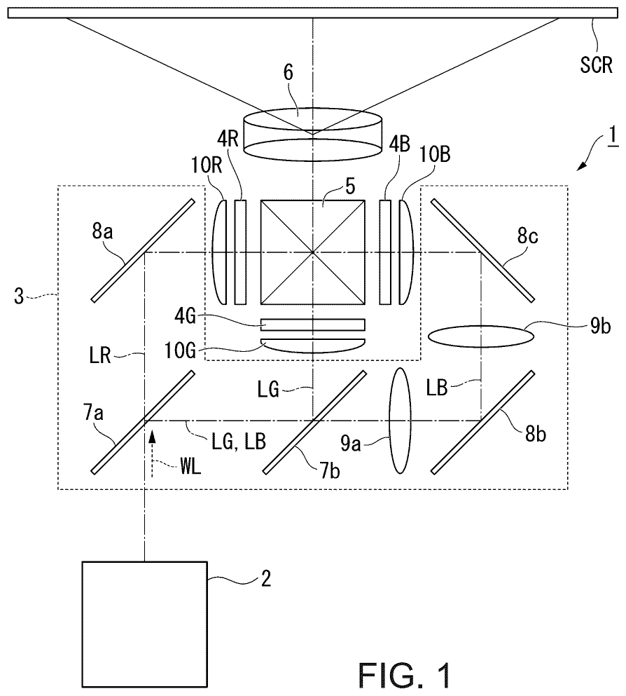

FIG. 1 is a schematic configuration diagram showing a projector according to the present embodiment.

As shown in FIG. 1, the projector 1 of the present embodiment is a projection-type image display device that displays an image on a screen SCR. The projector 1 includes a light source device 2, a color separation optical system 3, a light modulation device 4R, a light modulation device 4G, a light modulation device 4B, a combining optical system 5, and a projection optical device 6.

The light source device 2 emits white illumination light WL toward the color separation optical system 3. The configuration of the light source device 2 will be described later in detail.

The color separation optical system 3 separates the illumination light WL emitted from the light source device 2 into red light LR, green light LG, and blue light LB. The color separation optical system 3 includes a first dichroic mirror 7a, a second dichroic mirror 7b, a first total reflection mirror 8a, a second total reflection mirror 8b, a third total reflection mirror 8c, a first relay lens 9a, and a second relay lens 9b.

The first dichroic mirror 7a separates the illumination light WL from the light source device 2 into the red light LR and light including the green light LG and the blue light LB. The first dichroic mirror 7a transmits the red light LR and reflects the light including the green light LG and the blue light LB. On the other hand, the second dichroic mirror 7b reflects the green light LG and transmits the blue light LB. As a result, the second dichroic mirror 7b separates the light containing the green light LG and the blue light LB into the green light LG and the blue light LB.

The first total reflection mirror 8a is disposed in the optical path of the red light LR, and reflects the red light LR transmitted through the first dichroic mirror 7a toward the light modulation device 4R. On the other hand, the second total reflection mirror 8b and the third total reflection mirror 8c are disposed in the light path of the blue light LB, and guide the blue light LB transmitted through the second dichroic mirror 7b to the light modulation device 4B. The green light LG is reflected from the second dichroic mirror 7b toward the light modulation device 4G.

The first relay lens 9a is disposed between the second dichroic mirror 7b and the second total reflection mirror 8b in the optical path of the blue light LB. The second relay lens 9b is disposed between the second total reflection mirror 8b and the third total reflection mirror 8c in the optical path of the blue light LB. The first relay lens 9a and the second relay lens 9b compensate for the optical loss of the blue light LB caused by the optical path length of the blue light LB is longer than the optical path length of the red light LR or the green light LG.

The light modulation device 4R modulates the red light LR in accordance with image information to form image light corresponding to the red light LR. The light modulation device 4G modulates the green light LG in accordance with image information to form image light corresponding to the green light LG. The light modulation device 4B modulates the blue light LB in accordance with image information to form image light corresponding to the blue light LB.

Each of the light modulation device 4R, the light modulation device 4G, and the light modulation device 4B uses, for example, a transmissive liquid crystal panel. Polarizing plates (not shown) are disposed on the incident side and the emission side of the liquid crystal panel.

A field lens 10R is disposed on the incident side of the light modulation device 4R. The field lens 10R parallelize the red light LR incident on the light modulation device 4R. A field lens 10G is disposed on the incident side of the light modulation device 4G. The field lens 10G parallelizes the green light LG incident on the light modulation device 4G. A field lens 10B is disposed on the incident side of the light modulation device 4B. The field lens 10B parallelizes the blue light LB incident on the light modulation device 4B.

The image light emitted from the light modulation device 4R, the light modulation device 4G, and the light modulation device 4B is incident on the combining optical system 5. The combining optical system 5 combines image light corresponding to the red light LR, the green light LG, and the blue light LB, and emits the combined image light toward the projection optical device 6. The combining optical system 5 uses, for example, a cross dichroic prism.

The projection optical device 6 includes a plurality of projection lenses. The projection optical device 6 enlarges and projects the image light combined by the combining optical system 5 onto the screen SCR. As a result, an enlarged image is displayed on the screen SCR.

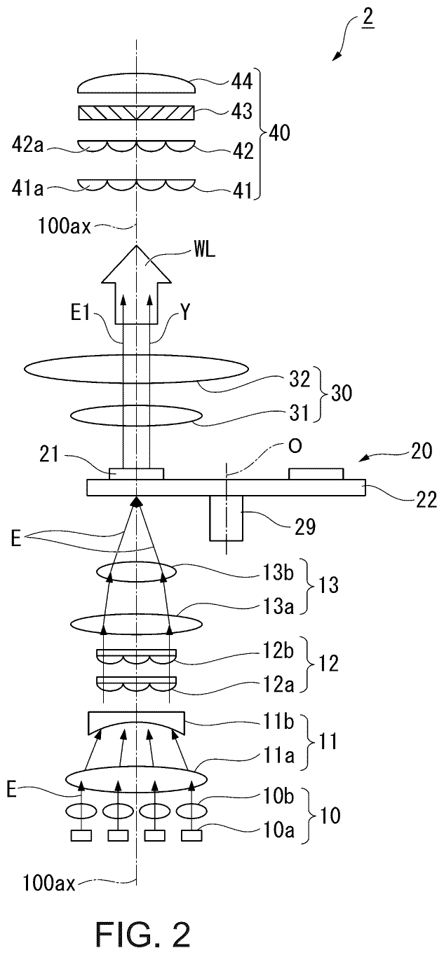

The configuration of the light source device 2 will be described below with reference to FIG. 2. FIG. 2 is a schematic configuration diagram showing the light source device 2 according to the present embodiment.

As shown in FIG. 2, the light source device 2 includes a light source 10, an afocal optical system 11, a homogenizer optical system 12, a condensing optical system 13, a wavelength conversion device 20, a pickup optical system 30, and a uniform illumination optical system 40.

The light source 10 is composed of a plurality of semiconductor lasers 10a that emit blue excitation light E made of laser light, and a plurality of collimator lenses 10b. The plurality of semiconductor lasers 10a are disposed in an array in a plane perpendicular to the illumination optical axis 100ax. The collimator lenses 10b are disposed in an array in a plane perpendicular to the illumination optical axis 100ax so as to correspond to the respective semiconductor lasers 10a. The collimator lenses 10b convert the excitation light E emitted from the semiconductor lasers 10a corresponding to the collimator lenses 10b into parallel light.

The excitation light E in the present embodiment corresponds to an example of “first light” in the present disclosure.

The afocal optical system 11 includes, for example, a convex lens 11a and a concave lens 11b. The afocal optical system 11 reduces the luminous flux diameter of the excitation light E formed of a parallel luminous flux emitted from the light source 10.

The homogenizer optical system 12 includes, for example, a first multi-lens array 12a and a second multi-lens array 12b. The homogenizer optical system 12 makes the light intensity distribution of the excitation light on the phosphor layer 21 of the wavelength conversion device 20 into a uniform distribution, that is, a so-called top hat distribution. The homogenizer optical system 12, together with the condensing optical system 13, causes a plurality of small luminous flux emitted from a plurality of lenses of the first multi-lens array 12a and the second multi-lens array 12b to overlap with each other on the phosphor layer 21 of the wavelength conversion device 20. This makes it possible to make the light intensity distribution of the excitation light E irradiated onto the phosphor layer 21 uniform.

The condensing optical system 13 includes, for example, a first lens 13a and a second lens 13b. In the present embodiment, the first lens 13a and the second lens 13b are each formed of a convex lens. The condensing optical system 13 is disposed in the optical path from the homogenizer optical system 12 to the wavelength conversion device 20, and focuses the excitation light E to make it incident on the phosphor layer 21 of the wavelength conversion device 20.

Next, a configuration of the wavelength conversion device 20 will be described.

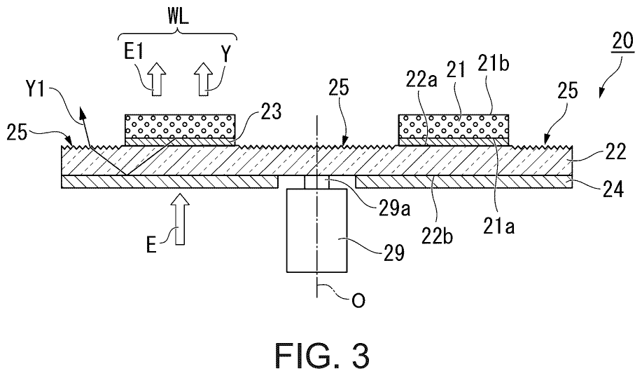

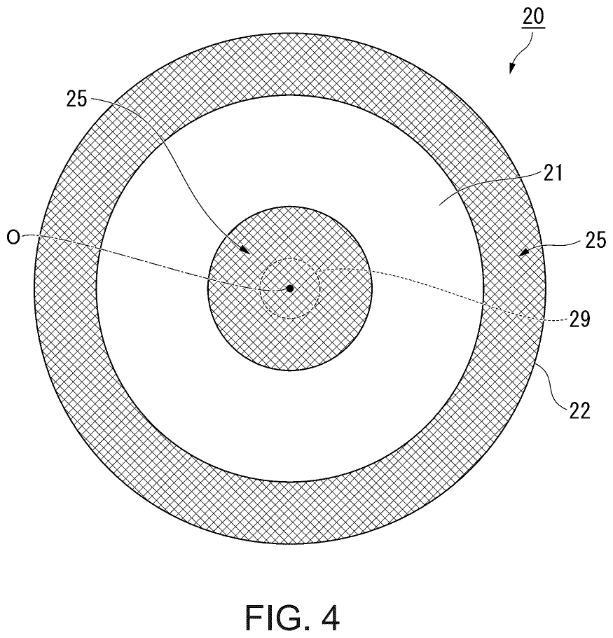

FIG. 3 is a cross-sectional view illustrating a configuration of the wavelength conversion device 20. FIG. 3 corresponds to a cross section of the wavelength conversion device 20 cut along a plane including the illumination optical axis 100ax in FIG. 2 FIG. 4 is a plan view illustrating a configuration of wavelength conversion device 20. FIG. 4 is a diagram of the wavelength conversion device 20 viewed from a direction parallel to the illumination optical axis 100ax in FIG. 2.

As shown in FIG. 3, a wavelength conversion device 20 according to the present embodiment includes a phosphor layer 21, a light transmissive substrate 22, a dichroic film 23, an anti-reflection film 24, an uneven structure 25, and a rotation drive section 29. In the present embodiment, the phosphor layer 21 corresponds to an example of a “wavelength conversion layer” of the present disclosure.

The rotation drive section 29 is configured by a motor. The rotation drive section 29 has a rotation shaft section 29a that is rotatable about a rotation axis O, which is an imaginary axial line. The rotation shaft section 29a rotatably supports the light transmissive substrate 22.

In the following description, a direction orthogonal to the rotation axis O is referred to as a “radially direction”, a side of the radial direction approaching the rotation axis O is referred to as a “radially inner side”, and a side of the radial direction away from the rotation axis O is referred to as a “radial outer side”.

The light transmissive substrate 22 has a first surface 22a on which the phosphor layer 21 is provided, and a second surface 22b opposite to the first surface 22a. The light transmissive substrate 22 is formed of a disc-shaped base material having translucency such as alumina, sapphire, or glass, or the like.

The phosphor layer 21 converts the excitation light E incident thereon after passing through the light transmissive substrate 22 into fluorescence Y in a yellow wavelength band different from the blue wavelength band. The phosphor layer 21 of the present embodiment is formed in a ring shape around the rotation axis O on the first surface 22a of the disk-shaped light transmissive substrate 22. That is, the phosphor layer 21 is provided in an annular shape around the rotation axis O. The fluorescence Y in the present embodiment corresponds to an example of the “second light” in the present disclosure.

The phosphor layer 21 generates heat when emitting the fluorescence Y. When the temperature of the phosphor layer 21 becomes too high, the efficiency of wavelength conversion of the fluorescence Y may decrease, and the amount of emitted fluorescence Y may decrease. In the wavelength conversion device 20 of the present embodiment, the phosphor layer 21 rotates together with the light transmissive substrate 22, so that the incident position of the excitation light E on the phosphor layer 21 can be moved over time. This improves the cooling performance of the phosphor layer 21, thereby suppressing a decrease in the fluorescence conversion efficiency that accompanies an increase in temperature of the phosphor layer 21.

The phosphor layer 21 receives excitation light E from a back surface 21a facing the light transmissive substrate 22, and emits fluorescence Y from a front surface 21b. The wavelength conversion device 20 according to the present embodiment is a transmissive wavelength conversion device that emits the illumination light WL containing fluorescence Y from a front surface 21b opposite to a back surface 21a of the phosphor layer 21 onto which excitation light E is incident.

The phosphor layer 21 is a wavelength conversion member containing a ceramic phosphor composed of a polycrystalline phosphor. The fluorescence Y has a yellow waveband of, for example, 490 to 750 nm. That is, the fluorescence Y is yellow fluorescence containing a red light component and a green light component.

The phosphor layer 21 may include a single crystal phosphor instead of the polycrystalline phosphor. Alternatively, the phosphor layer 21 may be made of a material in which a large number of phosphor particles are dispersed in a binder made of glass or resin.

Specifically, the material of the phosphor layer 21 of the present embodiment includes, for example, an yttrium aluminum garnet (YAG)-based phosphor. Taking YAG: Ce, which contains cerium (Ce) as an activator, as an example, the material for the phosphor layer 21 may be a material obtained by mixing raw material powders containing constituent elements such as Y₂O₃, Al₂O₃, and CeO₃ and causing a solid-phase reaction; Y—Al—O amorphous particles obtained by a wet method such as a coprecipitation method or a sol-gel method; or YAG particles obtained by a gas-phase method such as a spray drying method, a flame pyrolysis method, or a thermal plasma method.

The dichroic film 23 is provided on the first surface 22a of the light transmissive substrate 22. Specifically, the dichroic film 23 is provided between the light transmissive substrate 22 and the phosphor layer 21. The dichroic film 23 has a size that overlaps the phosphor layer 21 in plan view. Therefore, the dichroic film 23 is formed at a position on the first surface 22a of the light transmissive substrate 22 corresponding to the area where the phosphor layer 21 is disposed, and is not formed in a region where the phosphor layer 21 is not disposed.

The dichroic film 23 has optical characteristics of transmitting the excitation light E and reflecting the fluorescence Y. The dichroic film 23 is formed of, for example, a dielectric multilayer film. That is, the phosphor layer 21 is provided on the first surface 22a side of the light transmissive substrate 22 via the dichroic film 23.

The excitation light E is incident on the light transmissive substrate 22 from the second surface 22b on the opposite side to the dichroic film 23. The anti-reflection film 24 is provided on the second surface 22b of the light transmissive substrate 22. The anti-reflection film 24 is formed of, for example, an AR coat. The anti-reflection film 24 suppresses reflection of the excitation light E at the interface between the second surface 22b of the light transmissive substrate 22 and an air layer. This allows the excitation light E to be efficiently incident on the second surface 22b and into the light transmissive substrate 22 via the anti-reflection film 24. The anti-reflection film 24 is not an essential component in the wavelength conversion device 20, and may be omitted as necessary.

The uneven structure 25 is provided on the first surface 22a side of the light transmissive substrate 22. The uneven structure 25 is provided in a region of the first surface 22a that does not overlap the phosphor layer 21. In the case of the present embodiment, the uneven structure 25 is disposed in a region of the first surface 22a where the dichroic film 23 is not provided. According to this configuration, the fluorescence Y can be efficiently incident on the uneven structure 25 from the first surface 22a.

The uneven structure 25 of the present embodiment is a rough surface formed by roughening a part of the first surface 22a. According to this configuration, the uneven structure 25 can be easily formed at a desired position of the first surface 22a by processing the first surface 22a.

The surface roughness of the rough surface constituting the uneven structure 25 is, for example, preferably 0.0059μ or more, and more preferably 0.0096μ or more in terms of arithmetic roughness average (Ra).

The phosphor layer 21 in the present embodiment, excitation light E is incident on the back surface 21a facing the light transmissive substrate 22, and fluorescence Y is emitted from the front surface 21b. The phosphor layer 21 converts the excitation light E in the blue wavelength band into fluorescence Y in a yellow wavelength band different from the blue wavelength band.

The phosphor layer 21 transmits and emits, in addition to the fluorescence Y, a portion of the excitation light E1 that has not been wavelength-converted. As a result, the wavelength conversion device 20 emits white illumination light WL containing the excitation light E1 and the fluorescence Y from the front surface 21b of the phosphor layer 21.

A part of the fluorescence Y generated in the phosphor layer 21 travels toward the light transmissive substrate 22 and incident on the dichroic film 23 provided on the first surface 22a. The fluorescence Y incident on the dichroic film 23 is mostly reflected in the direction opposite to the light transmissive substrate 22 and is emitted from the front surface 21b of the phosphor layer 21.

On the other hand, since the fluorescence Y is unpolarized light, the P-polarized component of the fluorescence Y incident on the dichroic film 23 at an angle close to Brewster's angle passes through the dichroic film 23 and enters the light transmissive substrate 22. The leaking fluorescence thus incident on the light transmissive substrate 22 propagates within the light transmissive substrate 22 by total reflection, and may be emitted to the outside from the side surface of the light transmissive substrate 22, causing a loss.

In contrast, the wavelength conversion device 20 of the present embodiment has the uneven structure 25 provided on the first surface 22a side of the light transmissive substrate 22, so that the leaking fluorescence Y1 propagating in the light transmissive substrate 22 is incident on the uneven structure 25. Since the uneven structure 25 is a rough surface facing various directions different from the first surface 22a, the leaking fluorescence Y1 incident on the uneven structure 25 is incident on the surface of the uneven structure 25 at an angle smaller than the critical angle, and is emitted to the outside without being totally reflected at the interface with the air layer.

As shown in FIG. 4, the uneven structure 25 is provided on both the radially inner side and the radially outer side of the annular phosphor layer 21 in the radial direction of the first surface. That is, the uneven structure 25 is disposed on both sides of the phosphor layer 21 in the radial direction of the first surface 22a of the disk-shaped light transmissive substrate 22. The leaking fluorescence Y1 leaking into the light transmissive substrate 22 propagates in all directions in the light transmissive substrate 22. According to this configuration, the uneven structure 25 can efficiently emit the leakage component of the fluorescence Y propagating in the radial direction in the light transmissive substrate 22 to the outside of the light transmissive substrate 22.

As shown in FIG. 2, the illumination light WL emitted from the wavelength conversion device 20 enters the pickup optical system 30.

The pickup optical system 30 includes, for example, a first collimating lens 31 and a second collimating lens 32. The pickup optical system 30 is a parallelizing system that substantially parallelizes the illumination light WL emitted from the wavelength conversion device 20. The first collimating lens 31 and the second collimating lens 32 are each formed of a convex lens. The light collimated by the pickup optical system 30 falls incident on the uniform illumination optical system 40.

The uniform illumination optical system 40 includes a first lens array 41, a second lens array 42, a polarization conversion element 43, and a superimposing lens 44.

The first lens array 41 has a plurality of first lenses 41a for dividing the illumination light WL from the light source device 2 into a plurality of partial luminous fluxes. The plurality of first lenses 41a are arranged in a matrix in a plane perpendicular to the illumination optical axis 100ax.

The second lens array 42 has a plurality of second lenses 42a corresponding to the plurality of first lenses 41a of the first lens array 41. The plurality of second lenses 42a are arranged in a matrix in a plane perpendicular to the illumination optical axis 100ax.

The second lens array 42, together with the superimposing lens 44, forms images of each of the first lenses 41a of the first lens array 41 near the image forming region of the corresponding one of the light modulation device 4R, the light modulation device 4G, and the light modulation device 4B.

The polarization conversion element 43 converts the light emitted from the second lens array 42 into linearly polarized light in a single direction. The polarization conversion element 43 includes, for example, a polarization separation film and a retardation plate (not shown).

The superimposing lens 44 focuses partial luminous flux emitted from the polarization conversion element 43 and superimposes them in the vicinity of an image formation region of the light modulation device 4R, the light modulation device 4G, and the light modulation device 4B.

As described above, the light source device 2 according to the present embodiment includes a light source 10 that emits excitation light E, a phosphor layer 21 that converts the excitation light E: incident from the light source 10 into fluorescence Y of a yellow wavelength band different from the excitation light E, a light transmissive substrate 22 having a first surface 22a and a second surface 22b opposite the first surface 22a, with the phosphor layer 21 provided on the first surface 22a side, a dichroic film 23 provided between the first surface 22a of the light transmissive substrate 22 and the phosphor layer 21, which transmits the excitation light E and reflects the fluorescence Y, and an uneven structure 25 provided on the first surface 22a side of the light transmissive substrate 22.

According to the light source device 2 of the present embodiment, even when a part of the fluorescence Y is transmitted through the dichroic film 23 and leaks into the light transmissive substrate 22, the leaking fluorescence Y1 that has leaked into the light transmissive substrate 22 can be extracted as a part of the illumination light WL from the first surface 22a side of the light transmissive substrate 22 by the uneven structure 25. Therefore, the light source device 2 according to the present embodiment can increase the amount of fluorescence Y that can be used as illumination light WL, and therefore can increase the light utilization efficiency of the fluorescence Y to generate bright illumination light WL.

The projector 1 according to the present embodiment includes the light source device 2, the light modulation devices 4R, 4G, and 4B that modulate the light incident from the light source device 2, and a projection optical device 6 that projects the light modulated by the light modulation devices 4R, 4G, and 4B.

The projector 1 according to the present embodiment, the bright illumination light WL incident from the light source device 2 is modulated, thereby making it possible to project a bright image.

### First Modification

Next, a first modification of the present disclosure will be described.

The present modification is different from the embodiment described above in the configuration of the uneven structure of the wavelength conversion device, and the other configurations are the same. Therefore, the configuration of the uneven structure will be mainly described below, and the description of the other configurations will be omitted.

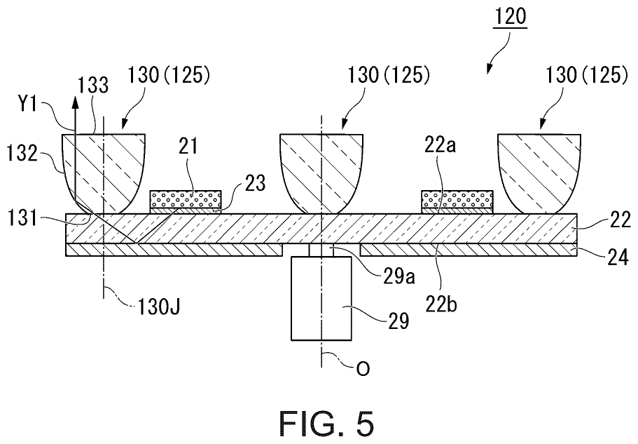

FIG. 5 is a cross-sectional view showing a configuration of wavelength conversion device 120 of the present modification. FIG. 5 is a cross-sectional view corresponding to FIG. 3.

As shown in FIG. 5, the wavelength conversion device 120 according to the present modification includes the phosphor layer 21, the light transmissive substrate 22, the dichroic film 23, the anti-reflection film 24, an uneven structure 125, and the rotation drive section 29.

The uneven structure 125 according to the present modification is formed of a first optical member 130 having a light incident surface 131, a reflection surface 132, and a light exit surface 133. The first optical member 130 is, for example, a compound parabolic concentrator (CPC). In the present modification, the first optical members 130 are provided on the radially inner side and the radially outer side of the first surface 22a of the light transmissive substrate 22.

The light incident surface 131 is a portion on which the fluorescence Y propagated through the light transmissive substrate 22 is incident. Since the uneven structure 125 of the present modification is formed separately from the light transmissive substrate 22, the light incident surface 131 abuts against the first surface 22a. In the case where the uneven structure 125 is formed integrally with the light transmissive substrate 22, the light incident surface 131 is formed of a part of the first surface 22a. The reflection surface 132 is a surface that reflects the fluorescence Y incident from the light incident surface 131, and is formed of a plurality of side surfaces that are in contact with the surface forming the light incident surface 131 and the light exit surface 133. The light exit surface 133 is a surface that emits the fluorescence Y reflected by the reflection surface 132.

The cross-sectional area of the first optical member 130 perpendicular to the optical axis 130J passing through the center of the first optical member 130 gradually increases from the light incident surface 131 toward the light exit surface 133. Therefore, the area of the light exit surface 133 is larger than the area of the light incident surface 131. The widths of the reflection surface 132 in the direction perpendicular to the optical axis 130J gradually increase from the light incident surface 131 toward the light exit surface 133. When the first optical member 130 is viewed from a direction perpendicular to the optical axis 130J, the shape of the reflection surface 132 is parabolic.

Note that instead of the CPC, the first optical member 130 may be a tapered rod in the shape of a truncated square pyramid in which the area of the emission end surface is larger than the area of the incident end surface.

In the present modification, the leaking fluorescence Y1 incident on the first optical member 130 having the uneven structure 125 changes direction as it travels inside the first optical member 130, each time it is totally reflected by the reflection surface 132, so as to approach a direction parallel to the optical axis 130J. In this way, the first optical member 130 converts the emission angle distribution of the leaking fluorescence Y1 emitted from the first surface 22a of the light transmissive substrate 22. Specifically, the first optical member 130 has an angle conversion function that makes the maximum emission angle of the leaking fluorescence Y1 on the light exit surface 133 smaller than the maximum incidence angle of the leaking fluorescence Y1 on the light incident surface 131.

In this way, according to the wavelength conversion device 120 of this modification, the CPC-like uneven structure 125 makes it possible to extract the leaking fluorescence Y1 that has leaked into the light transmissive substrate 22 to the outside of the light transmissive substrate 22 while suppressing the emission angle of the leaking fluorescence Y1. Therefore, by suppressing the spread of the leaking fluorescence Y1, the fluorescence Y can be efficiently incident on the subsequent optical system, thereby further improving the light utilization efficiency of the fluorescence Y.

### Second Modification

Next, a second modification of the light source device will be described.

The present modification is different from the embodiment described above in the configuration of the uneven structure of the wavelength conversion device, and the other configurations are the same. Therefore, the configuration of the uneven structure will be mainly described below, and the description of the other configurations will be omitted.

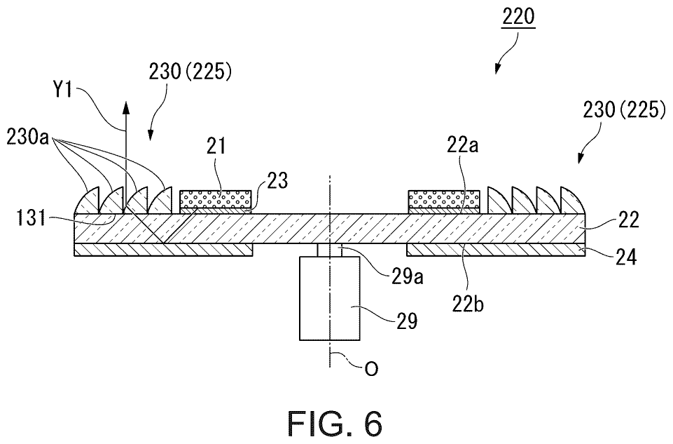

FIG. 6 is a cross-sectional view showing a configuration of wavelength conversion device 220 according to the present modification. FIG. 6 is a cross-sectional view corresponding to FIG. 3.

As shown in FIG. 6, a wavelength conversion device 220 of this modification includes a phosphor layer 21, a light transmissive substrate 22, a dichroic film 23, an anti-reflection film 24, an uneven structure 225, and a rotation drive section 29.

The uneven structure 225 in the present modification is composed of a Fresnel lens-shaped second optical member 230 that includes a plurality of lens surfaces 230a that refract and emit the leaking fluorescence Y1, which is a portion of the fluorescence Y that propagates through the light transmissive substrate 22 and is incident on the uneven structure 225. The plurality of lens surfaces 230a are concentrically arranged around the rotation axis O of the light transmissive substrate 22, and have a saw-toothed cross-sectional shape. In the present modification, the second optical member 230 is provided on the radially outer side of the first surface 22a of the light transmissive substrate 22.

In the present modification, the leaking fluorescence Y1 incident on the second optical member 230 having the uneven structure 225 is focused by multiple lens surfaces 230a as it travels inside the second optical member 230, and changes direction to approach a direction parallel to the rotation axis O. In this manner, the second optical member 230 can reduce the divergence angle of the leaking fluorescence Y1 emitted from the first surface 22a of the light transmissive substrate 22.

As described above, according to the wavelength conversion device 220 of the present modification, the Fresnel lens-shaped uneven structure 225 can suppress the spread of the leaking fluorescence Y1 that has leaked into the light transmissive substrate 22 and extract it to the outside of the light transmissive substrate 22. Therefore, similarly to the configuration of the first modification, the spread of the leaking fluorescence Y1 can be suppressed, so that the leakage fluorescence Y1 can be efficiently incident on the subsequent optical system, thereby improving the light utilization efficiency of the fluorescence Y.

Further, since a Fresnel lens-shaped member is used as the second optical member 230, an increase in size in the direction along the illumination optical axis 100ax can be suppressed compared to a configuration in which a plano-convex lens-shaped member is arranged on the first surface 22a of the light transmissive substrate 22. Therefore, the light utilization efficiency of the fluorescence Y can be improved while suppressing an increase in the size of the device configuration.

In addition, a second optical member 230 may be further provided on the radially inner side of the first surface 22a of the light transmissive substrate 22. In this case, the orientation of the multiple lens surfaces (sawtooth) of the second optical member 230 arranged radially inside the light transmissive substrate 22 is arranged symmetrically with the multiple lens surfaces 230a of the second optical member 230 arranged radially outside when the phosphor layer 21 is used as a reference. This allows the leaking fluorescence that has leaked from the phosphor layer 21 to the radially inner side of the light transmissive substrate 22 to be efficiently emitted from the first surface 22a.

The technical scope of the present disclosure is not limited to the above-described embodiments, and various modifications can be made without departing from the spirit of the present disclosure.

For example, although the wavelength conversion devices of the embodiment and the modification examples described above employ a rotation method in which the light transmissive substrate 22 rotates, the present disclosure is also applicable to a fixed wavelength conversion device in which the light transmissive substrate 22 does not rotate.

In the wavelength conversion device of the above embodiment and modification, an example has been given in which an uneven structure is arranged in an area of the first surface 22a where the dichroic film 23 is not provided, but the dichroic film 23 may cover the entire first surface 22a, and the uneven structure may be provided on the first surface 22a via the dichroic film. That is, the uneven structure may not be directly formed on the first surface 22a. The dichroic film 23 may be provided so as to cover the uneven structure 25 illustrated in FIG. 3.

Furthermore, the specific descriptions of the shape, number, arrangement, material, and the like of each component of the light source device and the projector are not limited to the above-described embodiment and can be modified as appropriate.

Hereinafter, a summary of the present disclosure is appended.

### Appendix 1

A light source device includes
a light source that emits first light;
a wavelength conversion layer that converts the first light incident from the light source into second light having a wavelength band different from that of the first light;
a light transmissive substrate having a first surface and a second surface opposite to the first surface, the wavelength conversion layer being provided on the first surface side;
a dichroic film that is provided between the first surface of the light transmissive substrate and the wavelength conversion layer, transmits the first light and reflects the second light; and
an uneven structure provided on the first surface side of the light transmissive substrate.

According to the light source device having this configuration, by satisfying Brewster's angle, a part of the second light that passed through the dichroic film and leaked into the light transmissive substrate can be extracted as a part of the illumination light from the first surface side of the light transmissive substrate 22 by the uneven structure. Therefore, the light source device having this configuration can increase the amount of the second light that can be used as illumination light, and can generate bright illumination light by improving the efficiency of use of the second light.

### Appendix 2

The light source device according to appendix 1, wherein the uneven structure is a rough surface formed by roughening a part of the first surface.

According to this configuration, the uneven structure can be easily formed at a desired position of the first surface by processing the first surface.

### Appendix 3

The light source device according to appendix 1 or 2, wherein
the uneven structure is formed of a first optical member having a light incident surface on which the second light propagated in the light transmissive substrate is incident, a reflection surface that reflects the second light incident from the light incident surface, and a light exit surface through which the second light reflected by the reflecting surface exits.

According to this configuration, the second light leaking into the light transmissive substrate can be extracted to the outside of the light transmissive substrate by the uneven structure in a state where the emission angle is suppressed. Therefore, by suppressing the spread of the second light, the second light can be efficiently incident on the subsequent optical system, and the utilization efficiency of the second light can be further improved.

### Appendix 4

The light source device according to appendix 1 or 2, wherein
the uneven structure is formed of a second optical member having a Fresnel lens shape including a plurality of lens surfaces that refract and emit the second light that propagates through the light transmissive substrate and that is incident on the uneven structure.

According to this configuration, the second light leaking into the light transmissive substrate can be extracted to the outside of the light-transmissive substrate in a state where the spread of the second light is suppressed by the Fresnel lens-like uneven structure. Therefore, by suppressing the spread of the second light, the second light can be efficiently incident on the subsequent optical system, and the utilization efficiency of the second light can be further improved. Furthermore, since a Fresnel lens-shaped second optical member is used, an increase in size in the direction along the illumination optical axis can be suppressed compared to the case where a plano-convex lens-shaped member is used. Therefore, it is possible to improve the light utilization efficiency of the second light while suppressing an increase in the size of the device configuration.

### Appendix 5

The light source device according to any one of appendices 1 to 4, wherein
the uneven structure is disposed in a region of the first surface where the dichroic film is not provided.

According to this configuration, the second light can be efficiently incident on the uneven structure from the first surface.

### Appendix 6

The light source device according to any one of appendices 1 to 5, wherein
the light transmissive substrate has a disk shape,
the wavelength conversion layer has an annular shape, and
the uneven structure is provided on each of a radially inner side and a radially outer side of the wavelength conversion layer in a radial direction of the first surface.

According to this configuration, the uneven structure can efficiently emit the leaking component of the second light propagating in the radial direction in the light transmissive substrate to the outside of the light transmissive substrate.

### Appendix 7

A projector includes
a light source device according to any one of appendixes 1 to 6
a light modulation device that modulates light incident from the light source device; and
a projection optical device that projects the light modulated by the light modulation device.

According to the projector having this configuration, it is possible to project a bright image by modulating bright illumination light incident from the light source device.

What is claimed is:

1. A light source device comprising:
a light source that emits first light;
a wavelength conversion layer that converts the first light incident from the light source into second light having a wavelength band different from that of the first light;
a light transmissive substrate having a first surface and a second surface opposite to the first surface, the wavelength conversion layer being provided on the first surface side;
a dichroic film that is provided between the first surface of the light transmissive substrate and the wavelength conversion layer, that transmits the first light, and that reflects the second light; and
an uneven structure provided on the first surface side of the light transmissive substrate.

2. The light source device according to claim 1, wherein
the uneven structure is a rough surface formed by roughening a part of the first surface.

3. The light source device according to claim 1, wherein
the uneven structure is formed of a first optical member having a light incident surface on which the second light propagated in the light transmissive substrate is incident, a reflection surface that reflects the second light incident from the light incident surface, and a light exit surface through which the second light reflected by the reflecting surface exits.

4. The light source device according to claim 1, wherein
the uneven structure is formed of a second optical member having a Fresnel lens shape including a plurality of lens surfaces that refract and emit the second light that propagates through the light transmissive substrate and that is incident on the uneven structure.

5. The light source device according to claim 1, wherein
the uneven structure is disposed in a region of the first surface where the dichroic film is not provided.

6. The light source device according to claim 1, wherein
the light transmissive substrate has a disk shape,
the wavelength conversion layer has an annular shape, and
the uneven structure is provided on each of a radially inner side and a radially outer side of the wavelength conversion layer in a radial direction of the first surface.

7. A projector comprising:
the light source device according to claim 1;
a light modulation device that modulates light incident from the light source device; and
a projection optical 1 device that projects the light modulated by the light modulation device.
